(19) United States
(12) Patent Application Publication
(10) Pub. No.: US 2021/0056329 A1
(43) Pub. Date: Feb. 25, 2021

(54) DRIVING STATE MONITORING DEVICE, DRIVING STATE MONITORING SYSTEM, DRIVING STATE MONITORING METHOD AND RECORDING MEDIUM

(71) Applicant: NEC CORPORATION, Minato-ku (JP)

(72) Inventors: Nana SAKUMA, Tokyo (JP); Hidenori TSUKAHARA, Tokyo (JP); Kazuki INAGAKI, Tokyo (JP); Yuta SHIMIZU, Tokyo (JP)

(73) Assignee: NEC CORPORATION, Minato-ku (JP)

(21) Appl. No.: 16/964,797

(22) PCT Filed: Jan. 18, 2019
(86) PCT No.: PCT/JP2019/001457

§ 371 Date: Jul. 24, 2020

(30) Foreign Application Priority Data
Jan. 25, 2018 (JP) 2018-010343

(51) Int. Cl. G06K 9/00; B60Q 9/00

(52) U.S. Cl. CPC G06K 9/00845; B60Q 9/00

(57) ABSTRACT

A driving state monitoring device includes: a sensing data acquisition unit that acquires, from a driving state sensing device, driving state data comprising driving states of a plurality of items and event data for notifying an event during driving; and a dangerous occasion driving data generation unit that generates dangerous occasion driving data comprising information of a driving state of any item selected from the plurality of items according to a driver attribute and the event data.

### TECHNICAL FIELD

The present invention relates to a driving state monitoring device, a driving state monitoring system, a driving state monitoring method, and a recording medium.

### BACKGROUND ART

A drive recorder is used as one mode of a driving state sensing device for sensing the driving state of a moving body. The drive recorder captures images of the state during driving of a moving body such as a car and stores the images. A technique related to a drive recorder is disclosed in Patent Document 1.

### PRIOR ART DOCUMENTS

### Patent Document

[Patent Document 1] Japanese Unexamined Patent Application, First Publication No. 2007-310510

### DISCLOSURE OF THE INVENTION

### Problem to be Solved by the Invention

There is a demand for a technique that exhibits more of an effect of safe driving by using the above-described driving state sensing device.

An example object of the present invention is to provide a driving state monitoring device, a driving state monitoring system, a driving state monitoring method, and a recording medium that solve the above problems.

### Means for Solving the Problem

According to a first example aspect of the present invention, a driving state monitoring device includes: a sensing data acquisition unit that acquires, from a driving state sensing device, driving state data including driving states of a plurality of items and event data for notifying an event during driving; and a dangerous occasion driving data generation unit that generates dangerous occasion driving data including information of a driving state of any item selected from the plurality of items according to a driver attribute and the event data.

According to a second example aspect of the present invention, a driving state monitoring system includes: a driving state monitoring device; and a driving state sensing device. The driving state monitoring device includes: a sensing data acquisition unit that acquires, from the driving state sensing device, driving state data including driving states of a plurality of items and event data for notifying an event during driving; and a dangerous occasion driving data generation unit that generates dangerous occasion driving data including information of a driving state of any item selected from the plurality of items according to a driver attribute and the event data.

According to a third example aspect of the present invention, a driving state monitoring method includes: acquiring, from a driving state sensing device, driving state data including driving states of a plurality of items and event data for notifying an event during driving; and generating dangerous occasion driving data including information of a driving state of any item selected from the plurality of items according to a driver attribute and the event data.

According to a fourth example aspect of the present invention, a recording medium stores a program that causes a computer to execute: acquiring, from a driving state sensing device, driving state data comprising driving states of a plurality of items and event data for notifying an event during driving; and generating dangerous occasion driving data comprising information of a driving state of any item selected from the plurality of items according to a driver attribute and the event data.

### Effect of the Invention

According to an example embodiment of the present invention, by using the driving state sensing device, information that contributes to safer driving can be fed back to a driver in accordance with attributes of the driver. More specifically, in accordance with attributes of the driver, more detailed data during dangerous driving which enables looking back efficiently are continuously fed back to the driver. Thereby, it is possible to provide safe driving support that is effective and that conforms to the driving policy of the company or the like to which the driver belongs.

### BRIEF DESCRIPTION OF THE DRAWINGS

FIG. 1 is a diagram that shows a driving state monitoring system according to an example embodiment of the present invention.

FIG. 2 is a hardware configuration diagram of a driving state monitoring device according to the example embodiment of the present invention.

FIG. 3 is a function block diagram of the driving state monitoring device according to the example embodiment of the present invention.

FIG. 4 is a diagram showing a hardware configuration of a drive recorder according to the example embodiment of the present invention.

FIG. 5 is a function block diagram of a control device of the drive recorder according to the example embodiment of the present invention.

FIG. 6 is a first diagram showing a processing flow of the drive recorder according to the example embodiment of the present invention.

FIG. 7 is a second diagram showing a processing flow of the drive recorder according to the example embodiment of the present invention.

FIG. 8 is a diagram showing a processing flow of the driving state monitoring device according to the example embodiment of the present invention.

FIG. 9 is a diagram showing a driving state monitoring device according to another example embodiment of the present invention.

### EXAMPLE EMBODIMENTS FOR CARRYING OUT THE INVENTION

Hereinbelow, a driving state monitoring device according to example embodiments of the present invention will be described with reference to the drawings.

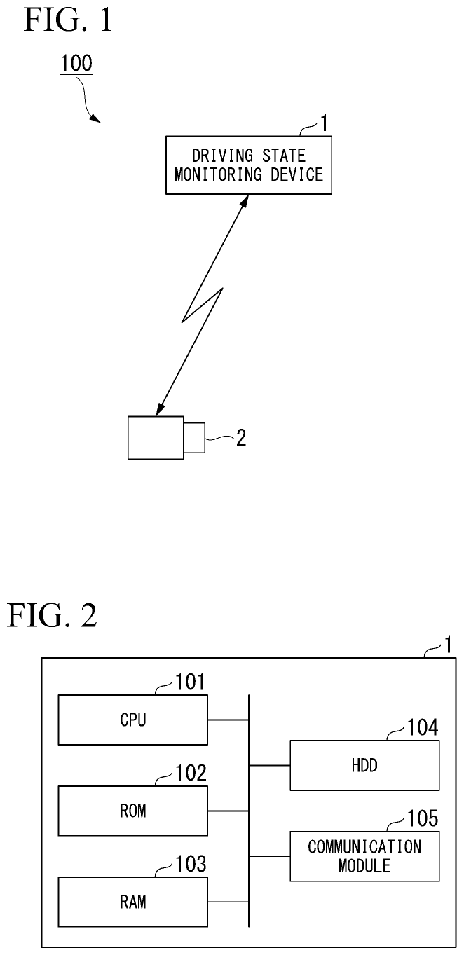

FIG. 1 is a diagram that shows a driving situation monitoring system according to an example embodiment of the present invention.

As shown in FIG. 1, the driving state monitoring system 100 includes a driving state monitoring device 1 and a drive recorder 2 that is one form of a driving state sensing device. The driving state monitoring device 1 and the drive recorder 2 are connected via a wireless communication network or a wired communication network. The drive recorder 2 is provided in a vehicle as an example.

FIG. 2 is a hardware configuration diagram of the driving state monitoring device.

As shown in this figure, the driving state monitoring device 1 is a computer including hardware such as a CPU (Central Processing Unit) 101, a ROM (Read Only Memory) 102, a RAM (Random Access Memory) 103, an HDD (Hard Disk Drive) 104, a communication module 105, and the like.

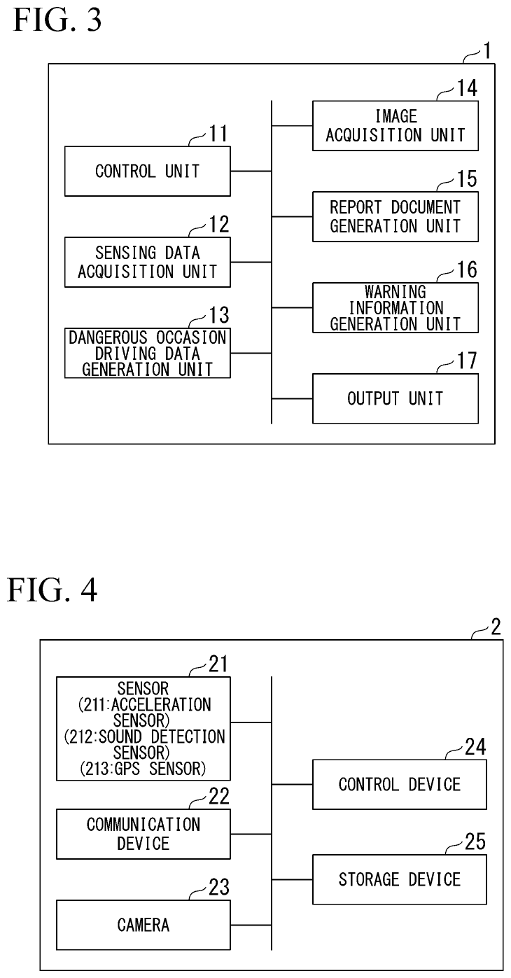

FIG. 3 is a function block diagram of the driving state monitoring device.

The driving state monitoring device 1 starts up when the power is turned on, and executes a driving state monitoring program stored in advance. Thereby, the driving state monitoring device 1 becomes capable of executing functions as a control unit 11, a sensing data acquisition unit 12, a dangerous occasion driving data generation unit 13, an image acquisition unit 14, a report document generation unit 15, a warning information generation unit 16, and an output unit 17.

The control unit 11 controls each function unit of the driving state monitoring device 1.

The sensing data acquisition unit 12 acquires driving state data including driving states of a plurality items and event data providing notification of events that have occurred while driving.

The dangerous occasion driving data generation unit 13 generates dangerous occasion driving data including information on the driving state of any of the items selected from the plurality of items in accordance with the driver attributes and the event data.

The image acquisition unit 14 acquires, from the drive recorder 2, image data determined on the basis of the driver attribute among the image data generated by the imaging of the drive recorder 2, at an acquisition timing based on the generation of the dangerous occasion driving data.

The report document generation unit 15 generates report document data according to the driver attributes using at least the dangerous occasion driving data.

The warning information generation unit 16 generates warning information according to the driver attributes when the dangerous occasion driving data is generated.

The output unit 17 outputs the report document data and the warning data.

FIG. 4 is a diagram showing the hardware configuration of the drive recorder.

The drive recorder 2 includes a sensor 21, a communication device 22, a camera 23, a control device 24, a storage device 25, and the like. The sensor 21 may be an acceleration sensor 211, a sound detection sensor 212, a GPS sensor 213, or the like. Note that such sensors 21 may be installed in the vehicle and outside the drive recorder 2, and the drive recorder 2 may acquire information sensed by the sensors 21.

The communication device 22 is communicatively connected to the driving state monitoring device 1. The camera 23 captures the outside and the inside of the vehicle to generate a moving image and a still image. The control device 24 controls each function of the drive recorder 2. The storage device 24 stores moving images, still images, and various kinds of information sensed by the sensor 21. The drive recorder 2 is communicatively connected to the driving state monitoring device 1 via a base station or the like. The control device 24 of the drive recorder 2 is a computer including a CPU, a ROM, a RAM, and the like.

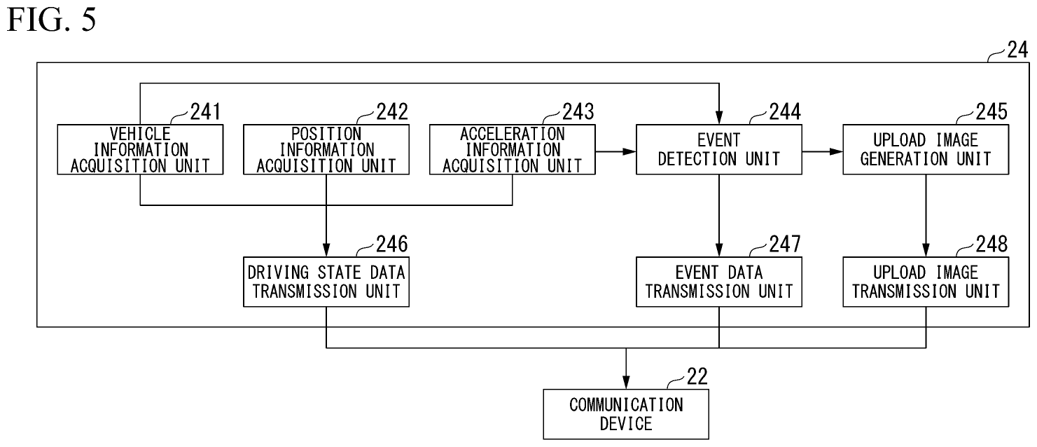

FIG. 5 is a function block diagram of the control device included in the drive recorder.

The control device 24 executes a control program when the drive recorder is activated. Thereby, the control device 24 is capable of performing execution of the functions of a vehicle information acquisition unit 241, a position information acquisition unit 242, an acceleration information acquisition unit 243, an event detection unit 244, an upload image generation unit 245, a driving state data transmission unit 246, an event data transmission unit 247, and an upload image transmission unit 248.

The vehicle information acquisition unit 241 acquires information relating to the vehicle (driver ID, vehicle type, vehicle ID) recorded in a memory inserted in the drive recorder, and other information, for example, the acceleration of the vehicle. The vehicle information acquisition unit 241 acquires vehicle information, which is different from the position information, wherein the vehicle information includes sensing information acquired by the sensor provided in the vehicle. The vehicle information that can be acquired by the vehicle information acquisition unit 241 may further include information such as a driving start time, a driving stop time, a vehicle speed corresponding to time, and a vehicle interior temperature.

The position information acquisition unit 242 acquires information on the position (latitude, longitude) of the vehicle corresponding to the time from the GPS sensor 213 or the like.

The acceleration information acquisition unit 243 acquires, from the acceleration sensor 211, information on the acceleration of the vehicle corresponding to the time.

The event detection unit 244 determines whether a desired event has occurred in the vehicle on the basis of the acceleration. A desired event is, for example, a dangerous event and may be an event such as sudden acceleration or sudden deceleration. More specifically, the event detection unit 244 detects whether or not an event has occurred, on the basis of a condition determined on the basis of driver attributes (operating condition data).

The upload image generation unit 245 acquires a moving image or a still image from the camera 23 by imaging with the camera 23, and generates a moving image during an event or a still image at the time an event occurs that is to be transmitted via the communication device 22. Specifically, the upload image generation unit 245 generates a moving image during an event or a still image at the time an event occurs on the basis of a condition determined based on the driver attribute.

The driving state data transmission unit 246 transmits driving state data including vehicle information, position information, and acceleration information to the driving state monitoring device 1.

The event data transmission unit 247 transmits event data when the event detection unit 244 has detected the occurrence of an event. The event data may include an identifier indicating the type of event.

The upload image transmission unit 248 transmits to the driving state monitoring device 1 the moving image at the time of an event or the still image at the time of an event generated by the upload image generation unit 245.

The aforementioned operation condition data includes, as an example, information of a risk level associated with a risk identifier, an acceleration condition, a speed condition, and a motion flag, and a dangerous driving classification associated with a risk type identifier, an acceleration direction, a speed, and a motion flag. Whether or not the operation flag is set is preset according to the driver attribute. In this way, the operation condition data is data that defines the risk level and the risk type based on the acceleration and the speed. The operation flag is set according to the driver attribute. The driver attribute indicates, for example, a company to which the driver belongs, and a person in charge at the company sets the operation flag of the driver who belongs to the company, and this is held in the operation condition data.

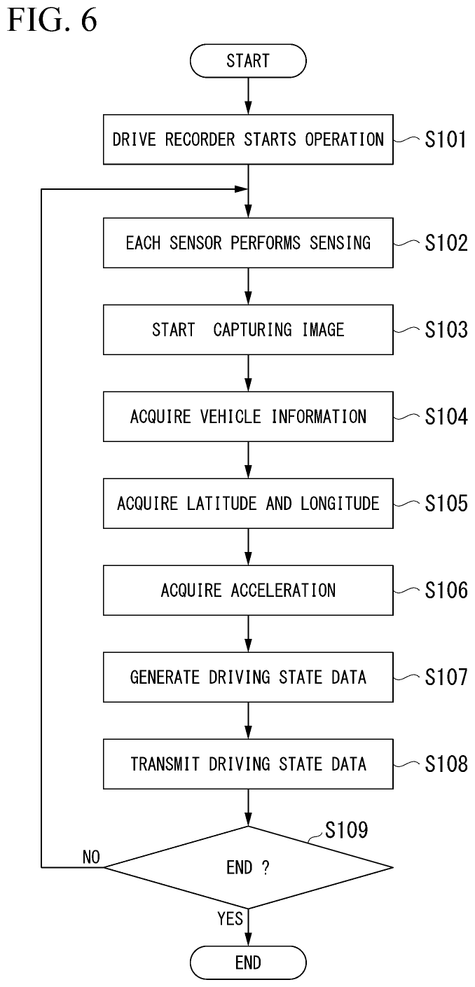

FIG. 6 is a first diagram showing a processing flow of the drive recorder.

Next, the processing flow of the driving state monitoring system will be explained step by step.

First, the transmission process of the driving state information in the drive recorder 2 will be described.

When the electrical system of the vehicle is activated, the drive recorder 2 starts operation (Step S101). The sensors 21 of the drive recorder 2 start various types of sensing after the drive recorder 2 starts (Step S102). The camera 23 also starts capturing images (Step S103). Then, during operation of the drive recorder 2, the vehicle information acquisition unit 241 of the control device 24 acquires vehicle information (Step S104). The vehicle information acquisition unit 241 may repeatedly acquire the sensing information included in the vehicle information at predetermined time intervals. The position information acquisition unit 242 also acquires the latitude and longitude from the GPS sensor 213 at predetermined time intervals (Step S105). In addition, the acceleration information acquisition unit 243 acquires the acceleration from the acceleration sensor 211 at predetermined time interval (Step S106). The predetermined time interval may be, for example, every 0.1 second. The driving state data transmission unit 246 acquires vehicle information, position information (latitude, longitude), and acceleration. The driving state data transmission unit 246 generates driving status data including the acquired information, the generation time of the driving state data, the ID of the drive recorder 2, and the driver ID (Step S107). The driving state data transmission unit 246 requests the communication device 22 to transmit the driving state data to the driving state monitoring device 1. The communication device 22 transmits the driving state data to the driving state monitoring device 1 (Step S108). The control device 24 determines whether the processing is ended (Step S109), and repeats the processing from Step S102 until the processing is ended.

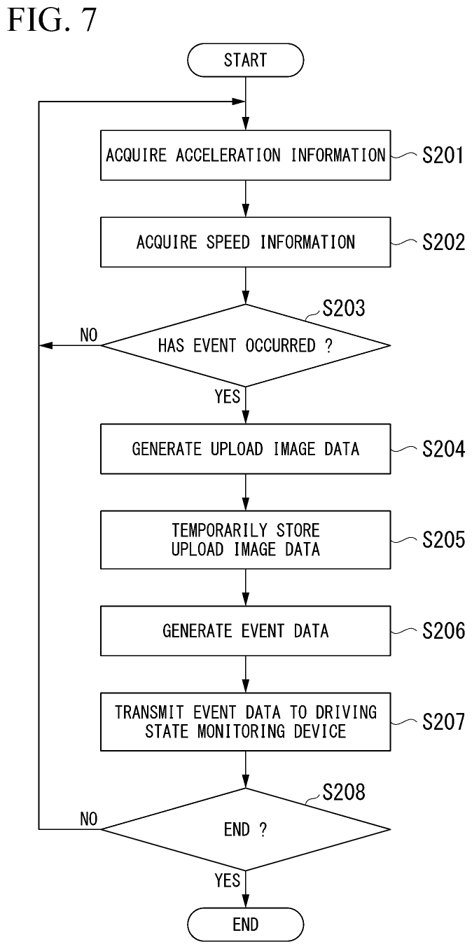

FIG. 7 is a second diagram showing the processing flow of the drive recorder.

The drive recorder 2 performs event detection processing in parallel with transmission processing of the driving state information. First, when the drive recorder 2 is started, the event detection unit 244 of the control device 24 acquires acceleration information from the acceleration information acquisition unit 243 at a predetermined time interval (Step S201). The event detection unit 244 also acquires speed information from the vehicle information acquisition unit 241 at a predetermined time interval (Step S202). The event detection unit 244 detects whether an event has occurred in the vehicle based on the temporal changes in the acceleration and speed of the vehicle (Step S203). An event is an event indicating a dangerous phenomenon in this example embodiment. Detection of whether or not this event has occurred may be determined according to the driver attributes.

Specifically, the event detection unit 244 acquires the operation condition data described above. The risk level information included in the operation condition data holds an operation flag for each acceleration corresponding to the risk level. The dangerous driving type information included in the operation condition data holds an operation flag for each acceleration direction condition and speed condition corresponding to the type of dangerous driving. The event detection unit 244 detects the occurrence of an event when it becomes a risk level of acceleration in which the operation flag indicates “1” and it matches the condition of the acceleration direction or speed of the dangerous driving type in which the operation flag indicates “1”. The event detection unit 244 may detect an event occurrence in the case of at least either one of it becoming a risk level of acceleration in which the operation flag indicates “1” or it matching the condition of the acceleration direction or speed of the dangerous driving type in which the operation flag indicates “1”. Since the operation flag held in the risk level information and the dangerous driving type information is set according to the driver attribute, it is possible to detect an event on the basis of the driver attribute.

Upon detecting an event occurrence, the event detection unit 244 instructs the upload image generation unit 245 to generate upload image data. The upload image generation unit 245 acquires a moving image captured by the drive recorder 2. Upon receiving the input of an event occurrence detection signal from the event detection unit 244, the upload image generation unit 245 generates upload image data based on the acquired moving image (Step S204). Specifically, the upload image generation unit 245 generates a still image or a moving image with a predetermined playback time. The number of still images, the still image imaging time with the event occurrence time serving as a reference, the playback time of the moving image, a time matching the moving image start timing with the event occurrence time in the moving image serving as a reference, and the like may be determined according to the driver attribute. The upload image generation unit 245 temporarily stores the upload image data including the generated still image or moving image, the generation time, the ID of the drive recorder 2, and the driver ID (Step S205). The upload image generation unit 245 may delete upload image data that has passed a predetermined period such as one week since being generated.

When the event detection unit 244 has detected the occurrence of an event, the event detection unit 244 generates event data (Step S206). The event data may include the acceleration, the speed, the event occurrence time, the ID of the drive recorder 2, and the driver ID at the time of detection of the event occurrence. The event data may also include position information of the vehicle (latitude, longitude) and other sensing information. The event data transmission unit 247 acquires the event data from the event detection unit 244. The event data transmission unit 247 instructs the communication device 22 to transmit the event data to the driving state monitoring device 1. The communication device 22 transmits the event data to the driving state monitoring device 1 (Step S207). The control device 24 determines whether the processing is ended (Step S208), and repeats the processing from Step S202 until the processing is ended.

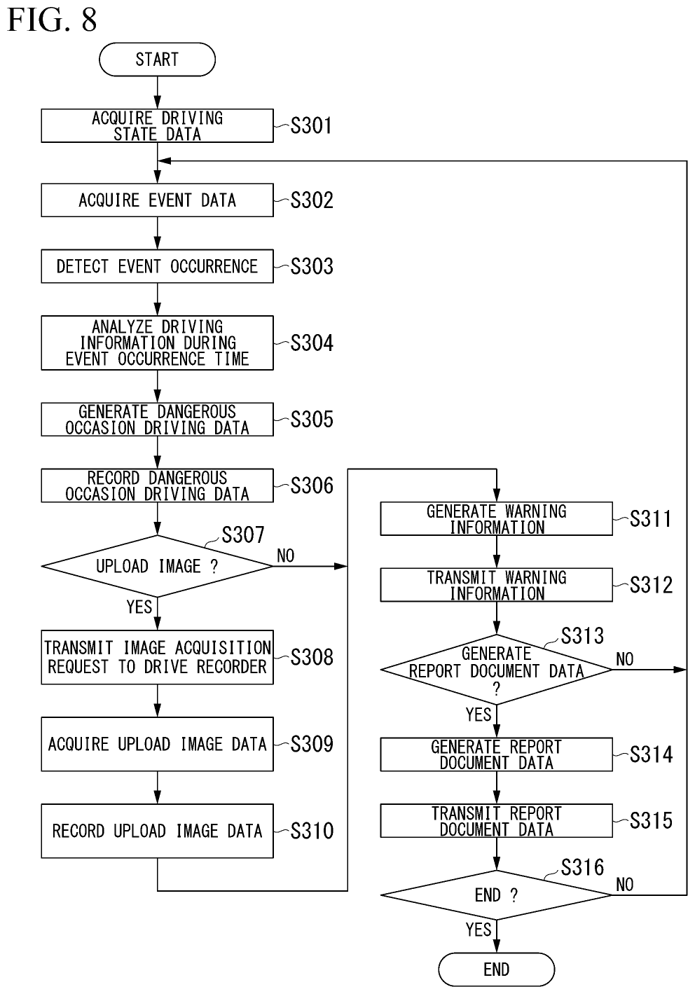

FIG. 8 is a diagram showing a processing flow of the driving state monitoring device.

In the driving state monitoring device 1, the sensing data acquisition unit 12 acquires via the communication module 105 the driving state data transmitted by the communication device 22 of the vehicle (Step S301). The sensing data acquisition unit 12 also acquires via the communication module 105 the event data transmitted by the communication device 22 of the vehicle (Step S302). The dangerous occasion driving data generation unit 13 detects the occurrence of an event in a vehicle equipped with the drive recorder 2 on the basis of the event data (Step S303). Upon detecting an event occurrence, the dangerous occasion driving data generation unit 13 analyzes the vehicle information during the event occurrence time with the event occurrence time serving as a reference (Step S304). For example, the event occurrence time may be one minute before and after the event occurrence time as a reference. The dangerous occasion driving data generation unit 13 calculates the event occurrence time specified by the respective times one minute before and one minute after the event occurrence time that is a reference, and extracts the information in the event occurrence time (vehicle information, position information, acceleration) from the received driving state data. The dangerous occasion driving data generation unit 13 acquires the ID of the drive recorder 2 or the driver ID included in the event data. The dangerous occasion driving data generation unit 13 acquires an analysis condition stored in advance in association with the ID of the drive recorder 2 or the driver ID. Since the analysis condition is specified by the ID of the drive recorder 2 or the driver ID, for example, the analysis condition is obtained in accordance with the company or individual driver using the drive recorder 2 mounted in the vehicle. The ID of the drive recorder 2 or the driver ID is one form of information indicating a driver attribute.

The dangerous occasion driving data generation unit 13 analyzes the information extracted from the driving state data (hereinafter, extracted information) on the basis of the event occurrence time based on the analysis condition, and generates dangerous occasion driving data as the analysis result (Step S305). The analysis condition includes information used for the analysis, information indicating a range indicated by the value of the information, information indicating an analysis method, and the like. The dangerous occasion driving data generation unit 13 analyzes the extracted information based on the analysis method indicated by the analysis condition, and, as a result, determines whether or not the event is an important event. As an example, the analysis condition may be a condition defined by the above-mentioned operating condition data. When the extracted information includes an acceleration for which the operation flag is “1”, the dangerous occasion driving data generation unit 13 reads the vehicle speed from the extracted information at each time spaced by a predetermined interval in the event occurrence time. The dangerous occasion driving data generation unit 13 specifies the dangerous driving type based on the transition of the acceleration and speed in the event occurrence time. When the operation flag corresponding to the identified risk type indicates “1”, the dangerous occasion driving data generation unit 13 generates dangerous occasion driving data including the identification information of the risk type. The dangerous occasion driving data may include acceleration and speed in the event occurrence time, extraction information extracted from other driving situation data, and the like. The output unit 17 acquires the generated dangerous occasion driving data. The output unit 17 records the dangerous occasion driving data in a storage unit such as the HDD 104 in association with the ID of the drive recorder 2 or the driver ID (Step S306).

The dangerous occasion driving data generation unit 13 determines whether to upload an image on the basis of the identified risk type (Step S307). The image upload determination condition is defined on the basis of driver attributes such as the ID of the drive recorder 2 and the driver ID, and may be stored in the driving state monitoring device 1 in advance. When the identified risk type is a risk type for which the upload of an image is sought, the dangerous occasion driving data generation unit 13 outputs an image acquisition request including at least the ID of the drive recorder 2 and the event occurrence time to the image acquisition unit 14. When the image acquisition unit 14 receives the image acquisition request from the dangerous occasion driving data generation unit 13, it transmits the image acquisition request, via the communication module 105, to the communication address of the drive recorder 2 that is specified in advance in association with the ID of the drive recorder 2 (Step S308).

The control device 24 of the drive recorder 2 receives the image acquisition request. Then, the upload image transmission unit 248 of the control device 24 specifies from the temporarily stored upload image data the upload image data corresponding to the time included in the event occurrence time extracted from the image acquisition request, among the upload image data generated by the upload image generation unit 245. The upload image transmission unit 248 temporarily stores the specified upload image data in a buffer or the like while awaits transmission. As an example, when the electrical system of the vehicle is again started and the driving state monitoring device 1 is restarted, the upload image transmission unit 248 transmits to the driving state monitoring device 1 via the communication device 22 the upload image data temporarily stored in the buffer and awaiting transmission. The image acquisition unit 14 acquires the upload image data transmitted from the drive recorder 2 (Step S309). The image acquisition unit 14 records the upload image data in association with the already generated dangerous occasion driving data (Step S310).

Through the above processing, the driving state monitoring device 1 can generate and store dangerous occasion driving data and upload image data corresponding to the driver attributes. According to the above-described processing, the upload image data are data of a still image or moving image that is part of a captured moving image generated in accordance with the driver attribute. Accordingly, it is possible to reduce the data amount of the upload image data transmitted to the driving state monitoring device 1. Further, the drive recorder 2 transmits the upload image data to the driving state monitoring device 1 at the time of restart. Accordingly, it is possible to transmit to the driving state monitoring device 1 upload image data that may have a large capacity in a time period in which there is a high possibility of the vehicle being stopped, which is a time period during which the communication quality is likely to be stable due to the vehicle being stopped.

The warning information generation unit 16 of the driving state monitoring device 1 generates warning information including at least the risk type identified by the dangerous occasion driving data generation unit 13 and the ID of the drive recorder 2 that has transmitted the driving state data (Step S311). The output unit 17 acquires the warning information generated by the warning information generation unit 16. The output unit 17 transmits the warning information to the communication address of the drive recorder 2 specified in advance in association with the ID of the drive recorder 2 via the communication module 105 (Step S312). The drive recorder 2 receives the warning information. When the drive recorder 2 receives the warning information, the drive recorder 2 may perform an output in accordance with the risk type included in the warning information. For example, the drive recorder 2 emits a sound or voice corresponding to the risk type. This allows the user to be warned according to the risk type.

The report document generation unit 15 of the driving state monitoring device 1 determines whether to generate report document data at a predetermined timing (Step S313), and when the predetermined timing is reached, it generates the report document data corresponding to the driver (Step S314). The generation timing of the report document data is, for example, once a day at a predetermined time, such as 24:00. As a specific example of generation of the report document, for example, the report document generation unit 15 acquires the ID dangerous occasion driving data and the upload image data of the drive recorder 2 associated with one driver ID recorded in a storage unit such as the HDD 104. The report document generation unit 15 acquires the report document generation condition stored in advance based on at least one of the driver ID and the ID of the drive recorder 2. The report document generation condition includes information such as the type of information to be posted in the report document and the destination of the report document. The report document generation unit 15 generates report document data on the basis of the report document generation condition. The report document data includes, for example, idling time indicating the time from the start of the vehicle included in the vehicle information, a radar chart according to the number of occurrences of each risk type, a score calculated by the report document generation unit 15 on the basis of risk type and the number of occurrences thereof, a risk ranking complied by the report document generation unit 15 in accordance with the score, and the like. When the report document data is generated, the output unit 17 acquires the report document data and transmits the report document data to a destination address based on the corresponding driver ID or ID of the drive recorder 2 (Step S315). The control unit 11 of the driving state monitoring device 1 determines whether the processing is ended (Step S316), and repeats the processing from Step S302 until the processing is ended.

Through the above processing, the driving state monitoring device 1 can generate report document data according to the driver attributes and send the report document data to a desired destination.

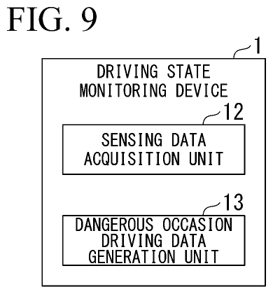

FIG. 9 is a diagram showing a driving state monitoring device according to another example embodiment of the present invention.

As shown in this figure, the driving state monitoring device 1 includes at least a sensing data acquisition unit 12 and a dangerous occasion driving data generation unit 13. The sensing data acquisition unit 12 acquires driving state data including driving states of a plurality of items and event data for notifying the occurrence of events during driving. The dangerous occasion driving data generation unit 13 generates dangerous occasion driving data including information on the driving state of any one of a plurality of items selected according to the driver attributes and the event data.

The above-mentioned driving state monitoring device 1 and the control device 24 of the drive recorder 2 have a computer system inside. The process of each process described above is stored in a computer-readable recording medium in the form of a program, and the above process is performed by the computer reading and executing the program.

The above program may be for realizing some of the functions described above. Further, it may be a so-called differential file (differential program) that can realize the functions described above in combination with a program already recorded in the computer system.

This application claims priority based on Japanese Patent Application No. 2018-010343, filed Jan. 25, 2018, the entire disclosure of which is incorporated herein by reference.

### INDUSTRIAL APPLICABILITY

The example embodiments of the present invention relate to a driving state monitoring device, a driving state monitoring system, a driving state monitoring method, and a recording medium.

### REFERENCE SYMBOLS

1: Driving state monitoring device

2: Drive recorder

11: Control unit

12: Sensing data acquisition unit

13: Dangerous occasion driving data generation unit

14: Image acquisition unit

15: Report document generation unit

16: Warning information generation unit

17: Output unit

21: Sensor

22: Communication device

23: Camera

24: Control device

25: Storage device

211: Acceleration sensor

212: Sound detection sensor

213: GPS sensor

241: Vehicle information acquisition unit

242: Position information acquisition unit

243: Acceleration information acquisition unit

244: Event detection unit

245: Upload image generation unit

246: Driving state data transmission unit

247: Event data transmission unit

248: Upload image transmission unit

1. A driving state monitoring device comprising:
a memory configured to store instructions; and
a processor configured to execute the instructions to:
acquire, from a driving state sensing device, driving state data comprising driving states of a plurality of items and event data for notifying an event during driving; and
generate dangerous occasion driving data comprising information of a driving state of any item selected from the plurality of items according to a driver attribute and the event data.

2. The driving state monitoring device according to claim 1,
wherein the processor is configured to execute the instructions to: generate report document data according to the driver attribute by using at least the dangerous occasion driving data.

3. The driving state monitoring device according to claim 1,
wherein the processor is configured to execute the instructions to: acquire, from the driving state sensing device, at an acquisition timing based on generation of the dangerous occasion driving data, image data determined based on the driver attribute among image data generated by capturing an image of the driving state sensing device.

4. The driving state monitoring device according to claim 1,
wherein the processor is configured to execute the instructions to: generate warning information according to the driver attribute upon generation of the dangerous occasion driving data.

5. A driving state monitoring system comprising:
a driving state monitoring device according to claim 1; and
the driving state sensing device.

6. The driving state monitoring system according to claim 5,
wherein the driving state sensing device comprises:
a memory configured to store instructions; and
a processor configured to execute the instructions stored in the memory of the driving state sensing device to: transmit to the driving state monitoring device image data according to the driver attribute based on an analysis result of the dangerous occasion driving data by the driving state monitoring device.

7. A driving state monitoring method comprising:
acquiring, from a driving state sensing device, driving state data comprising driving states of a plurality of items and event data for notifying an event during driving; and
generating dangerous occasion driving data comprising information of a driving state of any item selected from the plurality of items according to a driver attribute and the event data.

8. A non-transitory computer-readable recording medium that stores a program that causes a computer to execute:
acquiring, from a driving state sensing device, driving state data comprising driving states of a plurality of items and event data for notifying an event during driving; and
generating dangerous occasion driving data comprising information of a driving state of any item selected from the plurality of items according to a driver attribute and the event data.
